(19) United States
(12) Patent Application Publication
(10) Pub. No.: US 2024/0346335 A1
(43) Pub. Date: Oct. 17, 2024

(54) DYNAMIC ADJUSTMENT OF REQUEST CONFIGURATIONS

(71) Applicant: Dell Products L.P., Round Rock, TX (US)

(72) Inventors: Shibi Panikkar, Bangalore (IN); Sisir Samanta, Round Rock, TX (US)

(21) Appl. No.: 18/135,342

(22) Filed: Apr. 17, 2023

(51) Int. Cl. G06N 5/022

(52) U.S. Cl. CPC G06N 5/022

(57) ABSTRACT

Methods, apparatus, and processor-readable storage media for dynamic adjustment of request configurations are provided herein. An example method includes: determining that a value of a first parameter associated with a request varies over a particular period of time; predicting the value of the first parameter over the period of time based on historical time-series data; generating configurations for the request based on the predicted value of the first parameter, where each configuration corresponds to a different time interval within the period of time and includes: a second parameter, associated with a type of resource, that is fixed over the corresponding time interval and one or more uncertainty criteria corresponding to the second parameter; obtaining a selection of one of the configurations; and initiating one or more automated actions in response to at least one of the uncertainty criteria of the selected configuration being satisfied during the corresponding time interval.

### FIELD

The field relates generally to information processing systems, and more particularly to adjusting request configurations related to such systems.

### BACKGROUND

Organizations are increasingly providing complex and configurable technologies, including as-a-service technologies. For example, a given organization may provide hardware and/or software resources to one or more users at different geographical locations.

### SUMMARY

Illustrative embodiments of the disclosure provide techniques for dynamic adjustment of request configurations. An exemplary computer-implemented method includes obtaining a request from at least one user for one or more of hardware components and software components over a particular period of time; determining that a value of a first parameter associated with the request varies over the particular period of time; predicting, using a machine learning-based process, the value of the first parameter over the particular period of time based at least in part on historical time-series data for the first parameter; generating a plurality of configurations for the request based at least in part on the predicted value of the first parameter, wherein each of the plurality of configurations corresponds to a different time interval within the particular period of time and comprises: (i) a second parameter, associated with a type of resource, that is fixed over the corresponding time interval and (ii) one or more uncertainty criteria corresponding to the second parameter, wherein the one or more uncertainty criteria are based at least in part on at least one location associated with the at least one user and at least one type of the one or more of the hardware components and the software components; obtaining, from the at least one user, a selection of one of the plurality of configurations; and initiating one or more automated actions in response to at least one of the one or more uncertainty criteria of the selected configuration being satisfied during the corresponding time interval.

Illustrative embodiments can provide significant advantages relative to conventional techniques for providing configurable software and/or systems. For example, technical problems associated with providing such software and/or systems across multiple geographical regions are mitigated in one or more embodiments by generating multiple request configurations corresponding to a particular period of time for which at least one parameter is uncertain, predicting values of the at least one parameter using one or more machine learning processes, and dynamically adjusting the request configurations throughout the particular period of time based on the predicted values.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for dynamic adjustment of request configurations in an illustrative embodiment.

FIG. 2 shows a flow diagram of a process for generating and updating service configurations associated with a user request in an illustrative embodiment.

FIG. 3 is a table showing services with different characteristics in an illustrative embodiment.

FIG. 4 shows a flow diagram of a process for dynamic adjustment of request configurations in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Generally, a service provider refers to an entity (e.g., an organization) that provides hardware and/or software components that are utilized by one or more service consumers (e.g., one or more users, possibly associated with one or more other organizations). For example, a given service consumer can request such components based on a current and/or a projected resource demand, and a service provider can provide a configuration of the components to fulfill the request. The term “components” in this context and elsewhere herein is intended to broadly construed so as to encompass, for example, components related to one or more hardware components (e.g., hard disk drives and/or processors), software components (e.g., operating system (OS) software and/or software applications), and/or other types of components related to as-a-service technologies.

In some embodiments, a given configuration (also referred to herein as a request configuration) can comprise a plurality of parameters, such as one or more time periods for which the configuration will be provided, one or more locations associated with the service consumer, one or more types of components, a number or size of one or more components, etc. In some situations, values associated with one or more of these parameters can be uncertain at the time of the request, such as an amount of hardware and/or software resources that are needed to meet fluctuating user demand or traffic.

Also, one or more of the parameters related to a given request can be uncertain due to factors outside the control of the service provider and/or the service consumer. By way of example, service providers are increasingly providing components in multiple geographic locations and/or countries using as-a-service models, and one or more of the parameters can fluctuate based on such locations (such as different amounts of hardware and/or software resources that are needed to meet fluctuating user demand or traffic).

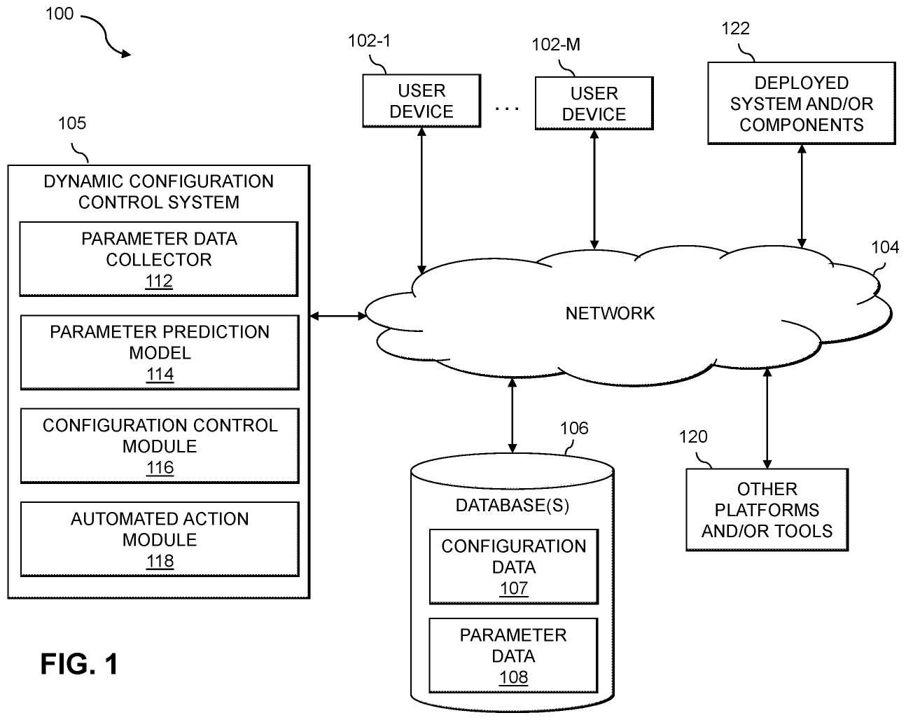

FIG. 1 shows a computer network (also referred to herein as an information processing system) 100 configured in accordance with an illustrative embodiment. The computer network 100 comprises a plurality of user devices 102-1, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a dynamic configuration control system 105, one or more deployed systems and/or components 122, and possibly one or more other platforms and/or tools 120 (such as a subscription management platform, for example).

The user devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.” The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the dynamic configuration control system 105 can have at least one associated database 106 configured to store configuration data 107 and parameter data 108. The configuration data 107 may pertain to, for example, request configurations associated with one or more users (e.g., corresponding to user devices 102), and the parameter data 108 may pertain to, for example, data collected for one or more parameters related to one or more of the request configurations.

An example database 106, such as depicted in the present embodiment, can be implemented using one or more storage systems associated with the dynamic configuration control system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the dynamic configuration control system 105 are one or more input-output devices, which illustratively comprise keyboards, displays or other types of input-output devices in any combination. Such input-output devices can be used, for example, to support one or more user interfaces to the dynamic configuration control system 105, as well as to support communication between dynamic configuration control system 105 and other related systems and devices not explicitly shown.

Additionally, the dynamic configuration control system 105 in the FIG. 1 embodiment is assumed to be implemented using at least one processing device. Each such processing device generally comprises at least one processor and an associated memory, and implements one or more functional modules for controlling certain features of the dynamic configuration control system 105.

More particularly, the dynamic configuration control system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the dynamic configuration control system 105 to communicate over the network 104 with the user devices 102, and illustratively comprises one or more conventional transceivers.

The dynamic configuration control system 105 further comprises a parameter data collector 112, a parameter prediction model 114, a configuration control module 116, and an automated action module 118.

Generally, the parameter data collector 112 can collect data related to one or parameters and can store such data as parameter data 108 in the at least one database 106, for example. In some embodiments, the parameter data 108 may include information related to one or more exchange rates that is collected from one or more online sources. For example, the parameter data collector 112 can be implemented as a software service that collects information related to changes to the one or more parameters (e.g., exchange rates and a current inflation factor for each combination of currency in a time-series data model).

The parameter prediction model 114 can process the parameter data 108 collected by the parameter data collector 112 to predict a value corresponding to the one or more parameters over a period of time corresponding to a given request (e.g., from one or more of the user devices 102). In at least one embodiment, the parameter prediction model 114 can be implemented using one or more machine learning models, such as a linear regression model and/or an autoregressive machine learning model. The parameter prediction model 114 can also be updated (e.g., retrained) during the period of time corresponding to the given request as additional information is collected by the parameter data collector 112. Generally, a linear regression model refers to a model that is trained using a supervised machine learning technique so that it models a linear relationship between a dependent variable and one or more independent variables, and an autoregression model refers to a machine learning model that measures the correlation between observations at previous time steps to output a predicted value for the next time step.

In some embodiments, a linear regression model can be trained using a supervised learning technique based on a set of training data (e.g., historical data related to an exchange rate) to estimate values of coefficients used in the linear model representation. As a non-limiting example, the linear regression model can be trained by optimizing the values of the coefficients by iteratively minimizing the error of the model on the training data. This may be done using a gradient descent process, where each coefficient is initialized with random value, and the sum of the squared errors are calculated for each pair of input and output values. A learning rate can be used as a scale factor, and the coefficients can be iteratively updated in the direction towards minimizing the error. The resulting linear regression model can then be used to predict a value of the parameter. It is to be appreciated that this is merely an example of a machine learning model, and that other machine learning prediction models can be used in other embodiments.

The configuration control module 116, in some embodiments, can determine the impact of the one or more parameters on the given request and can generate multiple request configurations based at least in part on the impact, as well as one or more uncertainty criteria (e.g., failing to meet or exceeding one or more designated thresholds) related to each of the multiple request configurations. When a given one of the multiple configurations is selected (e.g., by a user associated with the one or more user device 102), the configuration control module 116 can detect whether the at least one of the corresponding uncertainty criteria is satisfied, and then adjust the given request configuration and/or generate new request configurations for the service consumer to select from, as described in more detail elsewhere herein.

In one or more embodiments, the automated action module 118 can perform one or more automated actions based at least in part on an output of the configuration control module 116. The automated actions can include, for example, providing information (e.g., to one or more of the user devices 102) related to the configuration changes and/or interacting with one or more systems and/or applications (e.g., at least one of the other platforms and/or tools 120) so that the request configuration can be adjusted, or to implement one of the new request configurations, for example.

It is to be appreciated that this particular arrangement of elements 112, 114, 116, and 118 illustrated in the dynamic configuration control system 105 of the FIG. 1 embodiment is presented by way of example only, and alternative arrangements can be used in other embodiments. For example, the functionality associated with the elements 112, 114, 116, and 118 in other embodiments can be combined into a single module, or separated across a larger number of modules. As another example, multiple distinct processors can be used to implement different ones of the elements 112, 114, 116, and 118 or portions thereof.

At least portions of elements 112, 114, 116, and 118 may be implemented at least in part in the form of software that is stored in memory and executed by a processor.

It is to be understood that the particular set of elements shown in FIG. 1 for dynamic configuration control system 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the dynamic configuration control system 105 and database(s) 106 can be on and/or part of the same processing platform.

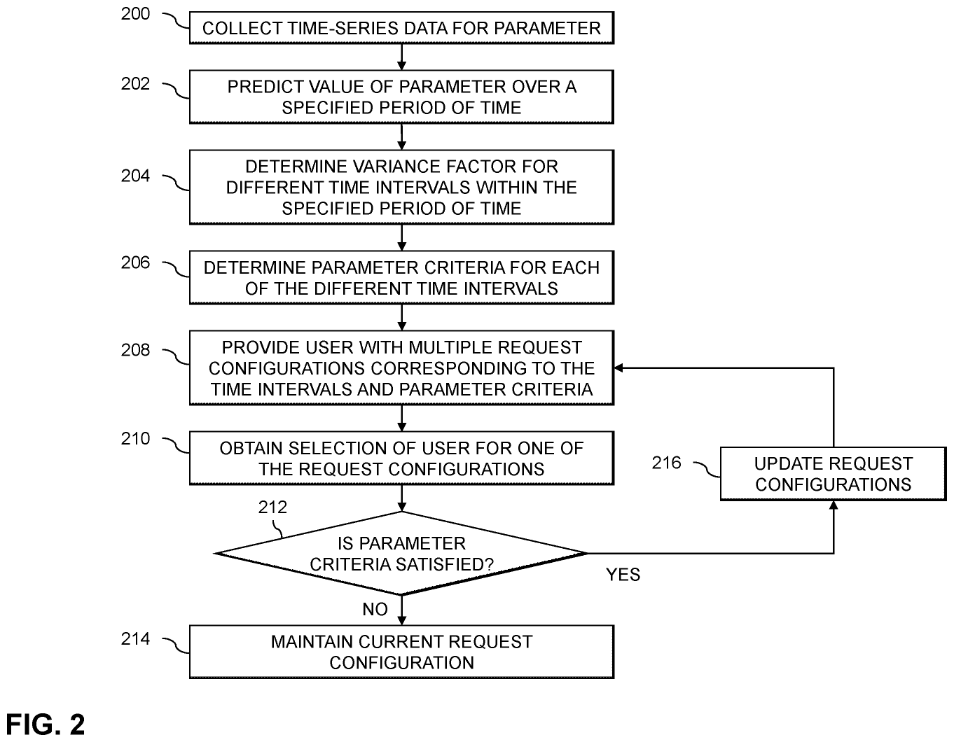

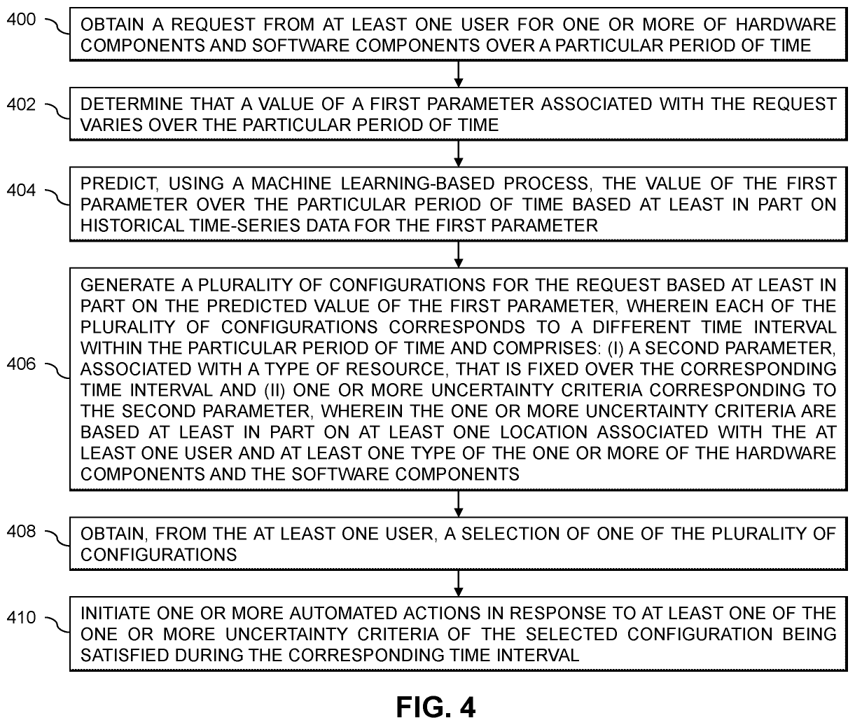

An exemplary process utilizing elements 112, 114, 116, and 118 of an example dynamic configuration control system 105 in computer network 100 will be described in more detail with reference to, for example, the flow diagrams of FIGS. 2 and 4.

In some embodiments, a system (e.g., the dynamic configuration control system 105), can capture information related to historical exchange rates, and project an impact of the exchange rate on a given request configuration. For example, a proposed price can be derived based on one or more factors, such as a projected exchange rate and an estimated term factor. The system can obtain a subscription proposal and price information along with a type of currency associated with a service consumer. For example, the system can derive rates and prices across multiple dimensions, such as: (i) a price fixed for an entire term (e.g., 1 year); (ii) a price fixed for the next six months; (iii) a price fixed for the next 3 months; and (iv) a price fixed for the next one month.

The service consumer can select one of these options to “block” the parameter (e.g., rate) for that time period. In this example, it is noted that higher dimensions may lower the chances of price changes, whereas lower dimensions may increase the chances of triggering a price change. This can bring advantages to service consumers when the exchange rate drops below a threshold, but it can negatively impact the service consumer if the exchange rate increases beyond the threshold.

Additionally, the system can automatically manage request configurations when one or more changes are made after the selected period of time, for example, to balance between revenue and provider costs.

FIG. 2 shows a flow diagram of a process for generating and updating service configurations associated with a user request in an illustrative embodiment. It is assumed the process in FIG. 2 is performed by the dynamic configuration control system 105 utilizing its elements 112, 114, 116, and 118, or portions thereof.

Step 200 includes collecting time-series data for a parameter. For example, the parameter may correspond to a parameter that varies (or is uncertain) over one or more periods of time. For example, the parameter may be an exchange rate or an amount of resources that are needed by a service consumer.

Step 202 includes predicting a value of the parameter over a specified period of time. The specified period of time, in some embodiments, may correspond to a total length of a requested subscription.

Step 204 includes determining a variance factor for different time intervals within the specified period of time.

Step 206 includes determining one or more parameter criteria for each of the different time intervals.

Step 208 includes providing a user with multiple request configurations corresponding to the time intervals and determined one or more parameter criteria.

Step 210 includes obtaining a selection (e.g., an input via user interface) of the user for one of the multiple request configurations.

Step 212 performs a test to determine whether the parameter criteria corresponding to the selection is satisfied. If the result of step 212 is no, then the process continues to step 214. Step 214 includes maintaining the current configuration (e.g., until at least one of the parameter criteria is satisfied or until the end of the requested subscription).

If the result of the test in step 212 is yes, then the process continues to step 216. Step 216 includes updating the request configurations. For example, step 216 can include updating the request configuration based on an updated prediction of the value of the parameter using additional time-series data that was collected for the parameter. By way of example, assume the specified period of time is three years, and a service consumer selects a request configuration having a time interval of six months. The request configuration can also define a fixed price for the six-month period, and the parameter criteria can correspond to an exchange rate. In such an example, a service provider may initially provide the components associated with the request configuration to the service consumer. If the exchange rate satisfies at least one of the parameter criteria within the first six months, then the result of step 212 would be yes, and the request configurations can be updated at step 216.

In one or more embodiments, the values for the one or more parameters (e.g., corresponding to step 202) can be predicted using a suitable prediction algorithm. For example, if a given one of the parameters is an exchange rate, then the prediction algorithm can predict the values of the exchange rate over one or more timelines (e.g., 1-month timeline, 3-month timeline, 6-month timeline, 12-month timeline, 36-month timeline, etc.), based at least in part on historical patterns and an inflation factor, for example. Such predictions can be updated and/or changed in response to a change to an exchange rate, for example. In some embodiments, the prediction algorithm can correspond to a linear regression model or an autoregressive model, for example. Such models can be trained on historical data collected for the relevant parameter to generate a time-series forecast (or prediction) for the relevant parameter.

In some embodiments, the variance factors determined at step 204 can be derived based on different combinations of request configurations. For example, the term variance factor can be based on at least one of whether hardware and/or software is being provided, and whether resources are being provided using a third party or a first party. By way of example, for a 1-month interval (or time block), the term variance factor might be +5% (compounded monthly); for a 3-month interval, the term variance factor might be +4% (compounded monthly); for a 6-month interval the term variance factor might be +2% (compounded monthly); and for a 12-month block, the term variance factor might be +1% (compounded monthly).

In some embodiments, one or more of the term variance factors can be derived based on the following formula to determine the term variance:

$$V = ( R - r ) * \frac{100}{T}$$

In the equation above, V is the term variance, R is the projected rate, r is the current rate, and T is the term in months. Thus, in such embodiments, a variance factor can be derived for multiple different time durations that are applicable to deriving a price.

In at least one embodiment, a software service can be implemented to determine different thresholds (or criteria) for respective combinations of configuration parameters (e.g., parameters associated with a request configuration). The configuration parameters can include, for example, a location (e.g., country), a customer segment, a total value, and/or other parameters associated with the request configuration. It is noted that a margin can vary for each of these combinations, and the threshold for the change in the exchange rate (which can be positive or negative) can vary for each configuration. The threshold for the change in the exchange rate, in some embodiments, can be used to trigger a change to one or more parameters related to the configuration (e.g., a price). In such embodiments, a dynamic threshold (or criteria) can be determined for a change in a permissible currency exchange rate with respect to the basic margin threshold for different combinations of parameters.

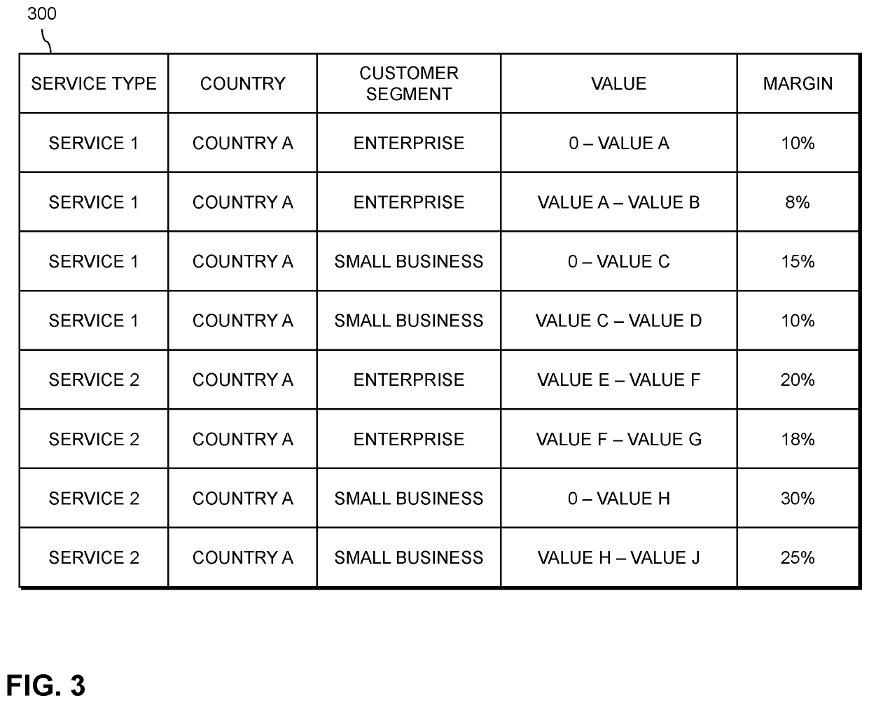

FIG. 3 is a table 300 showing services with different characteristics in an illustrative embodiment. In at least some embodiments the table can be used (e.g., by the configuration control module 116) as an input data structure for determining the dynamic thresholds. In this example, the table 300 includes the following fields: a service type field, a country field, a customer segment field, a value field, and a margin field. In some examples, the table 300 can be used to derive a minimum proposal value with the defined margin. This can be used as a threshold to trigger at least one new request configuration to be provided to the user, as explained in more detail elsewhere herein.

A non-limiting example of an equation to derive a given threshold is:

$$Threshold = \frac{( \begin{matrix}Current Actual Proposal Value - \\ Projected Proposal Value Covering Margin\end{matrix} )}{Current Actual Proposal Value}$$

In some embodiments, the configuration control module 116 can be implemented as a software service to calculate the fixed rates for each different time interval. For example, the configuration control module 116 can obtain input from one or more other applications, services, and/or tools (e.g., a sales system and/or a subscription management system). By way of example, the configuration control module 116 can obtain inputs at the end of each term period (e.g., the time period the user has selected to block a given parameter) pertaining to the proposal price, rate, term, offer, segment, etc. The configuration control module 116 can also obtain the projected exchange rate for each dimension of the term period (e.g., 1-month term, 3-month term, 6-month term, 12-month term, etc.), and verify the term variance. The configuration control module 116 can calculate the revised proposal rates and/or prices for each dimension of the term period. The threshold for the change in the exchange rate can be determined based on the base revenue margin, for example.

Additionally, the configuration control module 116 can determine if the projected rate or price breaches the threshold and can notify the service consumer to review the new prices or rates across multiple available term dimensions. The service consumer can accept the desired price or rate from among the available term dimensions. Accordingly, the configuration control module 116 can calculate and provide prices in multiple dimensions of term period for a given subscription proposal, and it can also help to offer the price for the next term period dimension for the proposal.

In at least some examples, a service provider may provide components to one or more locations that use one or more different currencies. Also, exchange rates may change throughout the time the components are deployed. For example, the service provider may provide such components to two or more locations that use different types of currency, which are possibly different than a currency associated with the service provider. Accordingly, the service provider may receive payments in multiple different currencies. One approach to address such issues includes using a single currency for every consumer regardless of the consumer's location or where the components are being provided. This approach can make it difficult for the consumer to project the cost of the components. Another approach includes maintaining fixed rates throughout the term. However, using fixed rates can introduce uncertainty for the provider. Thus, such issues make it difficult for service providers to globally deploy components associated with as-a-service technologies, for example.

At least some embodiments described herein can address one or more of these issues by dynamically adjusting request configurations, thereby bringing additional flexibility and certainty, while reducing complexity, for both service providers and service consumers. Also, at least one embodiment enables improved performance of hardware and/or software resources by enabling consumers to dynamically adjust the configuration throughout the term the components are deployed.

In some embodiments, the techniques described herein can be implemented using a pluggable software component for a subscription software application. Some embodiments provide multiple options for term rates in a local currency of the consumer for different periods of time (e.g., quarterly, yearly, annually, etc.). Additionally, providers can be given opportunities to revise prices in certain circumstances, for example, when a base rate deviation is higher than a determined threshold, as described in more detail elsewhere herein. Such embodiments can address issues with existing techniques by avoiding uncertainties related to currency exchange rates, while also allowing fixed rates for blocks of time.

FIG. 4 is a flow diagram of a process for dynamic adjustment of request configurations in an illustrative embodiment. It is to be understood that this particular process is only an example, and additional or alternative processes can be carried out in other embodiments.

In this embodiment, the process includes steps 400 through 410. These steps are assumed to be performed by the dynamic configuration control system 105 utilizing its elements 112, 114, 116, and 118.

Step 400 includes obtaining a request from at least one user for one or more of hardware components and software components over a particular period of time. Step 402 includes determining that a value of a first parameter associated with the request varies over the particular period of time. Step 404 includes predicting, using a machine learning-based process, the value of the first parameter over the particular period of time based at least in part on historical time-series data for the first parameter. Step 406 includes generating a plurality of configurations for the request based at least in part on the predicted value of the first parameter, wherein each of the plurality of configurations corresponds to a different time interval within the particular period of time and comprises: (i) a second parameter, associated with a type of resource, that is fixed over the corresponding time interval and (ii) one or more uncertainty criteria corresponding to the second parameter, wherein the one or more uncertainty criteria are based at least in part on at least one location associated with the at least one user and at least one type of the one or more of the hardware components and the software components. Step 408 includes obtaining, from the at least one user, a selection of one of the plurality of configurations. Step 410 includes initiating one or more automated actions in response to at least one of the one or more uncertainty criteria of the selected configuration being satisfied during the corresponding time interval.

The one or more automated actions may include generating one or more additional configurations for the request for a remaining portion of the particular period of time in response to the at least one of the one or more uncertainty criteria of the selected configuration being satisfied. The one or more automated actions may include at least one of: sending an alert to the at least one user; and adjusting at least a portion of the one or more of the hardware components and the software components associated with the request. The process may further include the following steps: obtaining additional time-series data for the first parameter over at least a portion of the time interval corresponding to the selected configuration; and updating the predicted value of the first parameter based at least in part on the additional time-series data. The machine learning-based process may include at least one of a linear regression model and an autoregressive model. The at least one location may be located within a first country, and at least one second location associated with an entity providing the one or more of the hardware components and the software components may be located within a different, second country. The one or more uncertainty criteria may be further based on a type of the at least one user.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to enable service providers to provide hardware and/or software components (e.g., related to as-a-service technologies) in a predictable and efficient manner across multiple geographical regions, even when certain parameters related to providing such components are uncertain.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

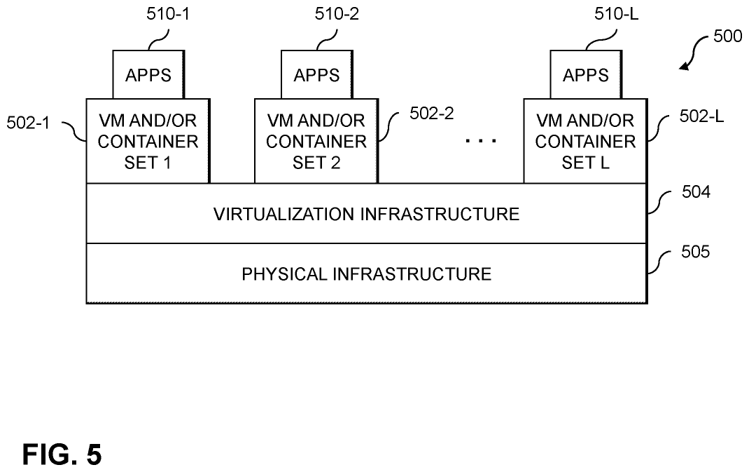

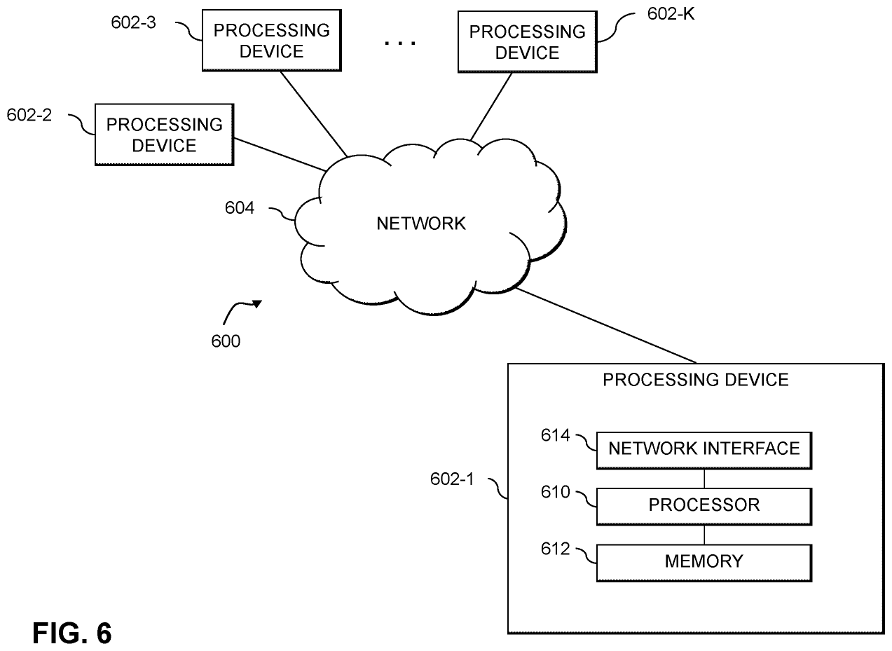

Illustrative embodiments of processing platforms will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, wherein the hypervisor platform has an associated virtual infrastructure management system. The underlying physical machines comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, a microcontroller, an ASIC, an FPGA or other type of processing circuitry, as well as portions or combinations of such circuitry elements.

The memory 612 comprises RAM, ROM or other types of memory, in any combination.

The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals.

Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining a request from at least one user for one or more of hardware components and software components over a particular period of time;
determining that a value of a first parameter associated with the request varies over the particular period of time;
predicting, using a machine learning-based process, the value of the first parameter over the particular period of time based at least in part on historical time-series data for the first parameter;
generating a plurality of configurations for the request based at least in part on the predicted value of the first parameter, wherein each of the plurality of configurations corresponds to a different time interval within the particular period of time and comprises: (i) a second parameter, associated with a type of resource, that is fixed over the corresponding time interval and (ii) one or more uncertainty criteria corresponding to the second parameter, wherein the one or more uncertainty criteria are based at least in part on at least one location associated with the at least one user and at least one type of the one or more of the hardware components and the software components;
obtaining, from the at least one user, a selection of one of the plurality of configurations; and
initiating one or more automated actions in response to at least one of the one or more uncertainty criteria of the selected configuration being satisfied during the corresponding time interval;
wherein the method is performed by at least one processing device comprising a processor coupled to a memory.

2. The computer-implemented method of claim 1, wherein the one or more automated actions comprises:
generating one or more additional configurations for the request for a remaining portion of the particular period of time in response to the at least one of the one or more uncertainty criteria of the selected configuration being satisfied.

3. The computer-implemented method of claim 1, wherein the one or more automated actions comprises at least one of:
sending an alert to the at least one user; and
adjusting at least a portion of the one or more of the hardware components and the software components associated with the request.

4. The computer-implemented method of claim 1, comprising:
obtaining additional time-series data for the first parameter over at least a portion of the time interval corresponding to the selected configuration; and
updating the predicted value of the first parameter based at least in part on the additional time-series data.

5. The computer-implemented method of claim 1, wherein the machine learning-based process comprises at least one of a linear regression model and an autoregressive model.

6. The computer-implemented method of claim 1, wherein the at least one location is located within a first country, and wherein at least one second location associated with an entity providing the one or more of the hardware components and the software components is located within a different, second country.

7. The computer-implemented method of claim 1, wherein the one or more uncertainty criteria are further based on a type of the at least one user.

8. A non-transitory processor-readable storage medium having stored therein program code of one or more software programs, wherein the program code when executed by at least one processing device causes the at least one processing device:
to obtain a request from at least one user for one or more of hardware components and software components over a particular period of time;
to determine that a value of a first parameter associated with the request varies over the particular period of time;
to predict, using a machine learning-based process, the value of the first parameter over the particular period of time based at least in part on historical time-series data for the first parameter;
to generate a plurality of configurations for the request based at least in part on the predicted value of the first parameter, wherein each of the plurality of configurations corresponds to a different time interval within the particular period of time and comprises: (i) a second parameter, associated with a type of resource, that is fixed over the corresponding time interval and (ii) one or more uncertainty criteria corresponding to the second parameter, wherein the one or more uncertainty criteria are based at least in part on at least one location associated with the at least one user and at least one type of the one or more of the hardware components and the software components;
to obtain, from the at least one user, a selection of one of the plurality of configurations; and
to initiate one or more automated actions in response to at least one of the one or more uncertainty criteria of the selected configuration being satisfied during the corresponding time interval.

9. The non-transitory processor-readable storage medium of claim 8, wherein the one or more automated actions comprises:
generating one or more additional configurations for the request for a remaining portion of the particular period of time in response to the at least one of the one or more uncertainty criteria of the selected configuration being satisfied.

10. The non-transitory processor-readable storage medium of claim 8, wherein the one or more automated actions comprises at least one of:
sending an alert to the at least one user; and
adjusting at least a portion of the one or more of the hardware components and the software components associated with the request.

11. The non-transitory processor-readable storage medium of claim 8, wherein the program code further causes the at least one processing device:
to obtain additional time-series data for the first parameter over at least a portion of the time interval corresponding to the selected configuration; and
to update the predicted value of the first parameter based at least in part on the additional time-series data.

12. The non-transitory processor-readable storage medium of claim 8, wherein the machine learning-based process comprises at least one of a linear regression model and an autoregressive model.

13. The non-transitory processor-readable storage medium of claim 8, wherein the at least one location is located within a first country, and wherein at least one second location associated with an entity providing the one or more of the hardware components and the software components is located within a different, second country.

14. The non-transitory processor-readable storage medium of claim 8, wherein the one or more uncertainty criteria are further based on a type of the at least one user.

15. An apparatus comprising:
at least one processing device comprising a processor coupled to a memory;
the at least one processing device being configured:
to obtain a request from at least one user for one or more of hardware components and software components over a particular period of time;
to determine that a value of a first parameter associated with the request varies over the particular period of time;
to predict, using a machine learning-based process, the value of the first parameter over the particular period of time based at least in part on historical time-series data for the first parameter;
to generate a plurality of configurations for the request based at least in part on the predicted value of the first parameter, wherein each of the plurality of configurations corresponds to a different time interval within the particular period of time and comprises: (i) a second parameter, associated with a type of resource, that is fixed over the corresponding time interval and (ii) one or more uncertainty criteria corresponding to the second parameter, wherein the one or more uncertainty criteria are based at least in part on at least one location associated with the at least one user and at least one type of the one or more of the hardware components and the software components;
to obtain, from the at least one user, a selection of one of the plurality of configurations; and
to initiate one or more automated actions in response to at least one of the one or more uncertainty criteria of the selected configuration being satisfied during the corresponding time interval.

16. The apparatus of claim 15, wherein the one or more automated actions comprises:
generating one or more additional configurations for the request for a remaining portion of the particular period of time in response to the at least one of the one or more uncertainty criteria of the selected configuration being satisfied.

17. The apparatus of claim 15, wherein the one or more automated actions comprises at least one of:
sending an alert to the at least one user; and
adjusting at least a portion of the one or more of the hardware components and the software components associated with the request.

18. The apparatus of claim 15, wherein the at least one processing is further configured:
to obtain additional time-series data for the first parameter over at least a portion of the time interval corresponding to the selected configuration; and
to update the predicted value of the first parameter based at least in part on the additional time-series data.

19. The apparatus of claim 15, wherein the machine learning-based process comprises at least one of a linear regression model and an autoregressive model.

20. The apparatus of claim 15, wherein the at least one location is located within a first country, and wherein at least one second location associated with an entity providing the one or more of the hardware components and the software components is located within a different, second country.
